(19) United States
(12) Patent Application Publication
(10) Pub. No.: US 2021/0217311 A1
(43) Pub. Date: Jul. 15, 2021

(54) CROWDSOURCED NAVIGATION SYSTEMS AND METHODS

(71) Applicant: Ford Global Technologies, LLC, Dearborn, MI (US)

(72) Inventors: Daniel Sullivan, Grosse Pointe, MI (US); James Issac, Ypsilanti, MI (US); Jeremy Lerner, Southfield, MI (US); Jason Woo, Northville, MI (US)

(73) Assignee: Ford Global Technologies, LLC, Dearborn, MI (US)

(21) Appl. No.: 16/741,416

(22) Filed: Jan. 13, 2020

(51) Int. Cl. G08G 1/14; G01C 21/36

(52) U.S. Cl. CPC G08G 1/143; G01C 21/3617; G01C 21/3691; G01C 21/3611

(57) ABSTRACT

Crowdsourced navigation systems and methods are provided herein. An example method includes receiving a selected destination location of a trip request input into a navigation system of a vehicle and suggesting a different final destination location rather than the selected destination location. The different final destination location can be selected based on commonality between final destination locations of additional trip requests of other vehicles that specified the selected destination location.

### FIELD

The present disclosure is generally directed to systems and methods that utilize parking-related, crowdsourced information to suggest navigation options to drivers.

### BACKGROUND

Drivers utilize navigation services within a vehicle or on their mobile device to navigate to a desired destination. Often, parking at a destination is limited and the driver may be forced to find an alternative location to park their vehicle. This alternative location may be in close proximity to the desired destination or may be located at a distance that is further away.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 illustrates an example graphical user interface that can be displayed on a navigation system of a vehicle.

FIG. 3 is a flowchart of an example method of the present disclosure.

FIG. 4 is a flowchart of another example method of the present disclosure.

### DETAILED DESCRIPTION

### Overview

Systems and methods disclosed may determine and provide navigation-related suggestions to drivers based on crowdsourced information. Some navigation-related suggestions can include parking options. For example, a driver may choose a selected destination location that they input into the navigation system of their vehicle or a mobile device. When the selected destination location has been inputted, the navigation service can suggest one or more alternative destination locations to the driver based on crowdsourced information. The crowdsourced information could include final/alternate destination locations for other drivers and vehicles that had also selected destination location, but ultimately ended up parking their vehicle in a final location that is different from the selected destination location. For example, these drivers may have parked their vehicles a specified distance away from the selected destination location because parking was not available at the selected destination location, or a parking garage, or an adjacent street provided a better parking option.

Thus, when the driver enters the selected destination location, a navigation service of the present disclosure can provide the driver with one or more suggestions related to one or more final destination locations where other drivers have frequently parked their vehicle. In some instances, these suggestions can be tailored based on driver preferences. For example, the navigation service may not suggest a location that is a relatively far walk from the selected destination location, if weather conditions indicate poor weather, and/or if short-distance transportation would be needed. These constraints may be driver-configurable.

With connected vehicle data, for each destination, a navigation service of the present disclosure can crowdsource the nearest parking locations from drivers who entered that destination into their navigation device. That is, when a driver enters a destination into their navigation device, they often drive directly to the destination and then away from it to park, or they put the destination in the navigation device and, based on prior experience, proceed directly to their preferred parking area.

Future drivers who enter a destination into their navigation device can be alerted (and redirected, if desired) to the nearest parking area that many people who visit that destination ended up parking in. For areas with moderate amounts of street parking, drivers can be sent to the originally selected destination and then routed along the most likely paths to find street parking. This can be accomplished through consultation of mapping services.

For areas with limited street parking, drivers can be directed straight to the nearest parking structure (those drivers who had this location as their destination ended up parking in). Further, real-time destination rates (i.e., the number of vehicles heading to a particular destination) and parking area popularity (i.e., the number of vehicles heading to that particular parking area) can be used to determine the ideal parking location based on price, walking distance to destination, availability of last mile transit options, expected parking availability, as well as the local weather and the expected walking route conditions to the final destination (e.g. many people will not want to walk very far if it is raining or snowing). Further, parking pricing can be incorporated, so if two parking areas are nearby the final destination, drivers can be directed to the less expensive option. In addition, businesses can subscribe to parking information to better understand their customers. For example, if two parking areas are equidistant to a popular restaurant but most people park in one of them, the other parking area owner can partner with the popular restaurant to offer a parking discount to patrons. In this manner, one aspect of the disclosure is directed to the combination of user inputted routing destinations and the true final location of the vehicle (i.e. where it was parked).

### Illustrative Embodiments

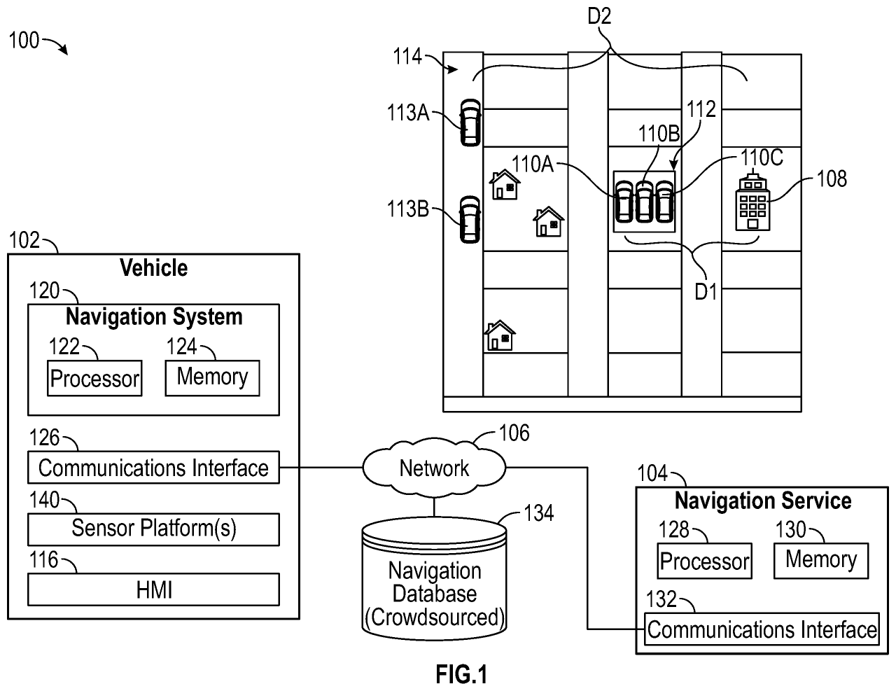

Turning now to the drawings, FIG. 1 depicts an illustrative architecture 100 in which techniques and structures of the present disclosure may be implemented. The architecture 100 comprises a vehicle 102, a navigation service 104, and a network 106. The network 106 can include any public and/or private network such as Wi-Fi, cellular, and the like.

For context, a driver of the vehicle 102 desires to arrive at a selected destination location 108. This selected destination location 108 has been chosen in the past by other drivers. For example other vehicles have chosen the selected destination location 108 such as vehicles 110A-110C, which ended up parking in a parking garage 112. Likewise, vehicles 113A-113B ended up parking on an adjacent street 11 in a nearby neighborhood. To be sure, each of these vehicles had drivers who initially specified the selected destination location 108 but their actual, final destination location was different than the selected destination location 108. The actual, final destination location can be tracked by the navigation service 104. As will be discussed below, the navigation service 104 can process these data from prior trip requests and determine suggestions for vehicles that subsequently enter the selected destination location 108 into their navigation system. For example, the vehicle 102 can comprise a human-machine interface (HMI 116) that receives the selected destination location and provides suggestions of alternative destination location(s) in accordance with the present disclosure. Alternatively, the navigation service 104 can cooperate with a mobile device 118 of the driver through a navigation application provided on the mobile device 118 to provide the suggestions.

For context, final destination locations include location where vehicles were parked after previously requesting a selected destination location in a trip request. An alternative destination location is suggested when a driver requests the selected destination location. The alternative destination location is a selection of one or more of these final destination locations that were previously identified. Also, the selected destination location could be entered into a navigation system of the vehicle 102, or could be learned from prior driver/vehicle information. For example, the selected destination location could be learned from observation of driver behaviors over time such as vehicle location history. The selected destination location could also be obtained from other sources such as a calendar (could be obtained from a calendar application of a mobile device), or an external database. In general, the choice of the selected destination location should not be limited to the options disclosed herein.

The vehicle 102 can include the use of various onboard vehicle sensors or sensor systems (collectively sensor platform(s) 140) to assess not only the parked location, but attributes of the parked location. Thus, while GPS data can be used to determine a final destination location for the vehicle, additional data can be obtained from, for example, ADAS cameras (advanced driver-assistance systems), radar sensors, ultrasonic sensors, and so forth). These additional can be used in combination with, or in lieu of, the GPS data for assessing vehicle location. Additional aspects of these features are described in greater detail infra.

In more detail, the vehicle 102 can comprise a navigation system 120 that comprises a processor 122 and memory 124. The memory 124 stores instructions that can be executed by the processor 122 to perform aspects of navigation as disclosed herein. When referring to operations executed by the navigation system 120, it will be understood that this includes the execution of instructions by the processor 122. The vehicle 102 can comprise a communications interface 126 that allows the navigation system 120 to communicate with the navigation service 104.

When a driver enters a selected destination location into the HMI 116 of the vehicle 102, the navigation system 120 provides the selected destination location to the navigation service 104 and receives suggestions from the navigation service 104 based on crowdsourced information. If the driver chooses one of these options, the navigation system 120 updates a navigation route for the vehicle 102 so that the vehicle 102 may arrive at an alternative destination location that is not the selected destination location that was originally requested by the user.

The navigation service 104 can be implemented as a physical or virtual server, or as an instance in a cloud environment. Generally, the navigation service 104 is configured to provide crowdsourced navigation suggestions to drivers, as noted above. The navigation service 104 comprises a processor 128 and memory 130. The memory 130 stores instructions that can be executed by the processor 128 to perform aspects of crowdsourced navigation data analysis and suggestions as disclosed herein. When referring to operations executed by the navigation service 104, it will be understood that this includes the execution of instructions by the processor 128. The navigation service 104 can access the network 106 using a communications interface 132.

The navigation service 104 may be configured to track and analyze trip information for various connected vehicles, such as those described above. The trip information can include a selected destination location 108, which is the initially selected destination that the driver would like to visit. This can be, for example, a theater, a restaurant, a residence, a school, an arbitrary location, or any other similar location.

The navigation service 104 can determine alternative/final destination location(s) suggestions from prior trip requests of other vehicles which initially specified the selected destination location 108 and ultimately parked in a different final destination than the selected destination location 108. As noted above, the navigation service 104 may determine that the vehicles 110A-110C each had a final destination location of the parking garage 112, while the vehicles 113A-113B each had a final destination location of the adjacent street 114.

In addition to assessing the selected destination location and the final destination location for prior trip requests of other vehicles, the navigation service 104 can assess other trip parameters such as a distance between the final destination location and the selected destination location 108. For example, in a particular trip request, a distance D1 can be determined between the final destination location for the vehicle 110A in the parking garage 112 and the selected destination location 108. This example distance D1 might be 500 yards. A distance D2 between the final destination location of a vehicle 113A on the adjacent street 114 and the selected destination location 108 might be half of a mile. Broadly, the navigation service 104 can determine commonality between these prior trip requests. This can include determining a distance between the selected destination location and the final destination location for each of the additional trip requests. For example, the navigation service 104 could determine that ten vehicles have parked within fifty yards of one another in an area that is a half of a mile from the selected destination location 108. The navigation service 104 can use this data to deduce that a parking option is available at this location due to the commonalities in attributes of the prior trip requests.

Using the distance values, the navigation service 104 can perform additional aspects of trip analysis such as characterizing the final destination location as a specific parking type. For example, the final destination location is determined to be a parking area when the final destination location where vehicles have parked has a size that meets or exceeds a parking area threshold. A parking area threshold size could include a specified perimeter size where multiple vehicles have been parked in the recent past.

Alternatively, it could be inferred that a parking garage exists when many vehicles have parked in a particular geographical location. For example, if thirty cars have recently parked in a location and that location is relatively smaller than that which would typically accommodate thirty cars, the navigation service 104 can infer that vehicles are located in a parking garage. The navigation service 104 can also consult mapping information that may identify various parking options available. Thus, by determining that many vehicles have parked at a particular location and cross-referencing a mapping information source (could be stored in a database accessible to the navigation service 104), the navigation service 104 may confirm that the location is a parking garage. A similar process can be used to identify other parking locations, such as streets using mapping information. For example, vehicles parked in a residential area may be inferred to be parked in a neighborhood.

In general, the navigation service 104 can be configured not only to determine alternative, final destination locations, but also determine identifying characteristics of these locations to provide to a driver. These identifying characteristics can include not only the parking type mentioned above, but also other information such as parking price, a weather condition, a weighting based on the final destination locations, and availability of last mile transit options between the final destination location and the selected destination location. These data can be used to apply constraints based on driver preference or allow the driver to select from available options on a more granular level. In some instances, the navigation service 104 can apply constraints based on user preferences to filter suggestions for the driver in an automated manner.

In one example, a driver may not desire to select a parking suggestion if there are not confirmed last mile transit options, especially when the parking suggestion is located far away from the selected destination location. What constitutes a suitable distance may vary from driver to driver. Also, the driver may specify that they do not desire to park any further than a specified distance from the selected destination location when it is raining or snowing outside. The navigation service 104 can consult weather services or other information databases that provide weather data.

The navigation service 104 can also obtain additional parking data or metrics and provide the same to drivers of connected vehicles. For example, the navigation service 104 can calculate and provide to a driver one or more metrics. The navigation service 104 could determine how many vehicles have recently chosen the selected destination location, but ended up parking in another parking location, such as the parking garage 112. For example, the navigation service 104 may determine that twelve vehicles have parked in the parking garage 112 in the last half hour after initially being routed to the selected destination location. This metric can further reinforce suggestions of the navigation service 104 for the driver to choose the parking garage 112 over attempting to park at the selected destination location.

In these instances, the navigation service 104 can offer an alternative destination suggestions based on a constraint such as parking cost. For example, the navigation service 104 could offer the parking garage 112 as a suggestion, but may instead provide the adjacent street 114 if the driver has a preference not to pay for parking.

The navigation service 104 could also evaluate a time of day of the trips or how long the vehicles drove around looking for parking before ending up at their final destination location. These data can assist the navigation service 104 in creating alternative destination/parking suggestions for drivers. For example, if a driver entered the selected destination location 108 into their navigation system for arrival at 5:30 pm, prior crowdsourced data may indicate that parking is difficult around the selected destination location 108 at that time due to the number of vehicles that have previously spent time driving around the selected destination location 108 looking for parking before ultimately ending up choosing an alternative final destination location.

When trip data are analyzed by the navigation service 104, these trip data can be stored in a crowdsourced navigation database 134 that can be accessed by the navigation service 104. The trip data can be stored as individual records or can be aggregated based on selected destination location in view of a final destination location.

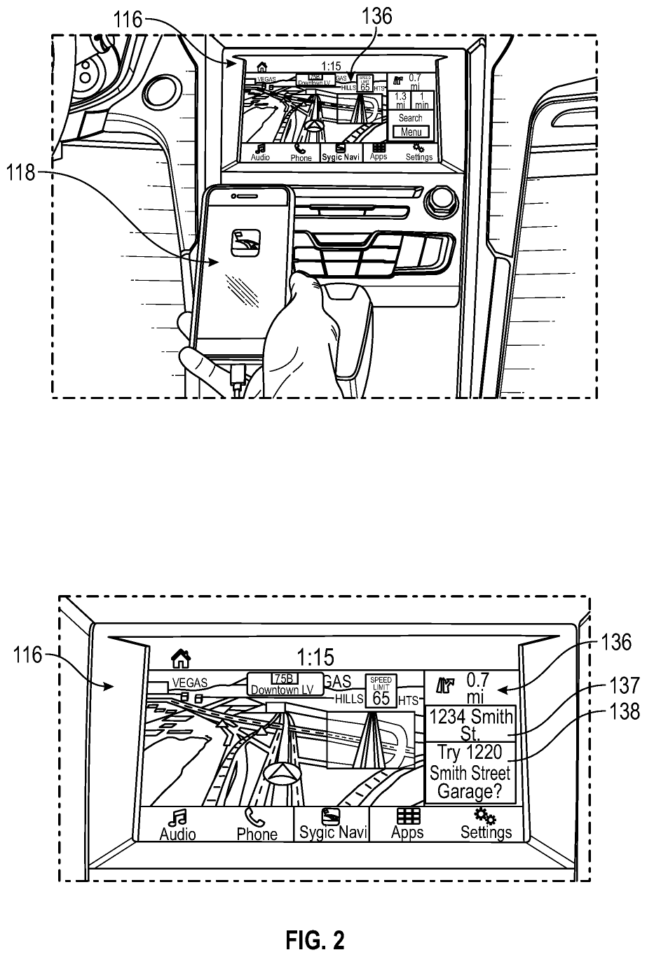

Based on the crowdsourced information, the navigation service 104 can provide suggestions to the driver that can be displayed on the HMI 116 of the vehicle 102. For example, in FIG. 2, the HMI 116 is illustrated with a navigation interface 136. The navigation interface 136 receives the selected destination location address 137 of 1234 Smith Street and provides a suggestion 138 for the vehicle 102 to alternatively select the parking garage 112 as its final destination. The parking garage 112 has an example address of 1220 Smith Street. The navigation system 120 of the vehicle 102 can be updated to identify the alternative/final destination location when the selected destination location is requested. That is, the navigation instructions provided to the driver may direct the driver to an alternative destination location rather than the selected destination location.

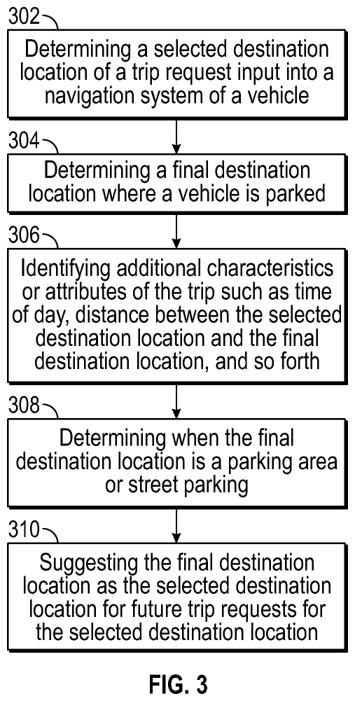

FIG. 3 is a flowchart of an example method of the present disclosure. This method generally relates to a method of determining when trip requests result in vehicles parking at a final destination location that is different from a selected destination location of a trip request. To be sure, these data can be obtained for a plurality of trip requests of a plurality of vehicles in order to build an actionable database used to provide intelligent suggestions to drivers.

The method includes a step 302 of determining a selected destination location of a trip request input into a navigation system of a vehicle. Next, the method can include a step 304 of determining a final destination location where a vehicle is parked. That is, the method can include identifying when the final destination location is not the selected destination location identified in the trip request. This could be based on thresholding. For example, if the final destination location is at least a quarter of a mile from the selected destination location, it can be inferred that parking was not available at the selected destination location, so the driver chose the final destination location instead. The method can also include a step 306 of identifying additional characteristics or attributes of the trip such as time of day, distance between the selected destination location and the final destination location, and so forth.

The method can include an optional step 308 of determining when the final destination location is a parking area or street parking. The method can further comprise a step 310 of suggesting the final destination location as the selected destination location for future trip requests for the selected destination location. For example, based on commonality between the trip requests that resulted in vehicles parking at the final destination location, the final destination location can be suggested for future trip requests that specify the selected destination location. As noted above, when multiple suggested parking options are identified, the method can include suggesting optional/additional final destination locations, allowing a driver to select one of the suggestions. As noted above, the method of FIG. 3 can be performed for many vehicles and trip requests to build a database of crowdsourced information.

As noted above, the method can include the use of various onboard vehicle sensors or sensor systems to assess not only the parked location, but attributes of the parked location. Thus, while GPS data can be used, additional data can be obtained from, for example, ADAS cameras (advanced driver-assistance systems), radar sensors, ultrasonic sensors, and so forth). In one example, images from ADAS cameras could be analyzed to determine if the final destination location is the originally selected destination location or an alternative destination location. Radar or ultrasonic signals could be used to determine if the vehicle is in a confined space or if the vehicle is in an open area. In addition to choosing of the originally selected destination location through other means that driver input, the selection of alternative destination locations could be selected based on prior vehicle location data. For example, an alternative destination location could be learned or inferred from past driver/vehicle behavior(s). Thus, if parking is not available at the originally selected destination location, the method can select from various alternative destination locations based on user preference or vehicle location history. The systems and methods disclosed herein can also learn from what options the driver chooses when offered suggestions as disclosed herein. That is, the navigation service can learn from accepted and declined suggestions to integrate driver preferences.

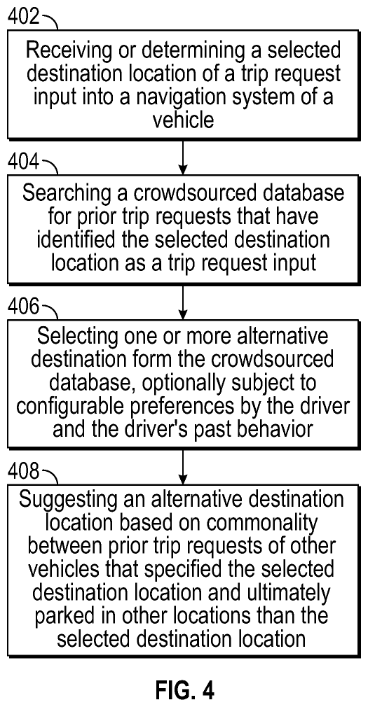

FIG. 4 is another method of the present disclosure. The method includes a step 402 of receiving or determining a selected destination location of a trip request input into a navigation system of a vehicle. For example, a driver can enter a destination into the navigation system of their vehicle. The selected destination location can be transmitted to a navigation service to identify suggestions for the selected destination location. Once the selected destination location is identified, the method can include a step 404 of searching a crowdsourced database for prior trip requests that have identified the selected destination location as a trip request input (e.g., input provided by a driver as a desired destination).

The method can further include a step 406 of selecting one or more alternative destinations from the crowdsourced database. The alternative destination locations could be selected based on prior vehicle location data. For example, an alternative destination location could be learned or inferred from past driver/vehicle behavior(s). The method can further include a step 408 of suggesting an alternative destination location based on commonality between prior trip requests of other vehicles that specified the selected destination location and ultimately parked in other locations than the selected destination location.

The alternative destination location can include a nearest parking area proximate the selected destination location. For example, based on the prior trip request analysis, the navigation service may identify a nearest parking area proximate the selected destination location. The method can include providing the driver with additional suggestions if or when such suggestions are available. In some instances, additional suggestions can be provided in response to a driver declining one or more previous suggestions.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
determining a selected destination location of a trip request input into a navigation system of a vehicle;
determining a final destination location where a vehicle is parked;
determining when the final destination location is a parking area or street parking; and
suggesting the final destination location as the selected destination location for future trip requests for the selected destination location.

2. The method according to claim 1, wherein the final destination location is determined to be a parking area when final destination location has a size that meets or exceeds a parking area threshold.

3. The method according to claim 1, further comprising selecting a street for the vehicle to park along when the final destination location is determined to be street parking.

4. The method according to claim 1, wherein the final destination location is determined to be street parking when additional trip requests for selected destination location resulted in other vehicles parking along one or more streets around the selected destination location.

5. The method according to claim 1, further comprising determining final destination locations for additional trip requests that specified the selected destination location.

6. The method according to claim 5, further comprising determining commonality between the final destination locations.

7. The method according to claim 6, further comprising determining a distance between the selected destination location and the final destination locations for each of the additional trip requests.

8. The method according to claim 6, further comprising applying a constraint prior to suggesting the final destination location, the constraint comprising any of a weather condition, a weighting based on the final destination locations, and availability of last mile transit options between the final destination location and the selected destination location.

9. The method according to claim 1, further comprising updating the navigation system to identify the final destination location when the selected destination location is requested.

10. A system, comprising:
a processor; and
a memory for storing instructions, the processor executing the instructions to:
receive a selected destination location of a trip request input into a navigation system of a vehicle;
determine a final destination location where a vehicle is parked, the final destination location being located at a distance away from the selected destination location; and
suggest the final destination location as an alternative destination location for future trip requests that specify the selected destination location.

11. The system according to claim 10, wherein the final destination location is suggested when a threshold number of additional prior trip requests of other vehicles have parked at the final destination location.

12. The system according to claim 10, wherein the processor is configured to:
determine additional prior trip requests that specified the selected destination location and ended up at the final destination location; and
determine commonality between the additional prior trip requests by determining a distance between the selected destination location and the final destination location for each of the additional prior trip requests.

13. The system according to claim 10, wherein the processor is configured to apply a constraint prior to suggesting the final destination location, the constraint comprising any of local weather, a weighting based on the final destination location, expected walking path conditions along the distance, availability of last mile transit options between the final destination location and the selected destination location, parking price, and expected parking availability.

14. The system according to claim 10, wherein the processor is configured to update the navigation system to identify the final destination location when the selected destination location is requested.

15. The system according to claim 10, wherein the final destination location is determined to be a parking area when final destination location has a size that meets or exceeds a parking area threshold.

16. A method, comprising:
receiving a selected destination location of a trip request input into a navigation system of a vehicle; and
suggesting an alternative destination location rather than the selected destination location, the alternative destination location being selected based on commonality between final destination locations of additional prior trip requests of other vehicles that specified the selected destination location.

17. The method according to claim 16, wherein the alternative destination location is determined to be street parking when the additional prior trip requests for selected destination location resulted in the other vehicles parking along one or more streets near the selected destination location.

18. The method according to claim 17, further comprising determining an additional alternative destination location, the additional alternative destination location being selected based on a parking cost for each of the additional alternative destination location and the alternative destination location.

19. The method according to claim 18, wherein the alternative destination location comprises a nearest parking area proximate the selected destination location.

20. The method according to claim 16, further comprising applying a constraint prior to suggesting the alternative destination location, the constraint comprising any of a weather condition, a weighting based on the alternative destination location, and availability of last mile transit options between the alternative destination location and the selected destination location.
